(19) United States
(12) Patent Application Publication
(10) Pub. No.: US 2008/0270009 A1
(43) Pub. Date: Oct. 30, 2008

(54) Method and System for Fuel Injection Simulation

(76) Inventor: Paul Spivak, Mayfield Heights, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/101,564

(22) Filed: Apr. 11, 2008

Related U.S. Application Data
(60) Provisional application No. 60/914,137, filed on Apr. 26, 2007.

(51) Int. Cl. F02D 41/24; F02M 65/00; G01M 15/00; G01M 19/00

(52) U.S. Cl. 701/105; 73/114.45

(57) ABSTRACT

A pulse width signal modifier comprises a fuel injector monitor in communication with an engine fuel injector. A signal modifier is configured to modify a 25% greater pulse width signal output to the fuel injector, wherein the modified pulse width signal is optimized for an E85 fuel blend. The fuel injector monitor is configured to monitor the engine fuel injector for a fault condition and communicate the fault condition to a fuel injector

### RELATED APPLICATIONS

The present application is a Continuation-in-Part of U.S. Ser. No. 60/914,137 and it claims a priority to the provisional's Apr. 26, 2007 filing date. The present application incorporates the subject matter disclosed in ('137) as if it is fully rewritten herein.

### BACKGROUND OF THE INVENTION

### Field of the Invention

The present invention relates to systems for the controlled combusting of fuels, and, more particularly, to internal combustion engine systems configured to operate on multiple types of fuel.

### SUMMARY OF THE INVENTION

In an internal combustion engine fuel is ignited and burned in a combustion chamber, wherein an exothermic reaction of the fuel with an oxidizer creates gases of high temperature and pressure. The pressure of the expanding gases directly act upon and cause a corresponding movement of pistons, rotors, or other elements, which are operationally engaged by a one or transmission systems to translate the element movement into working or motive forces.

The most common and important application of the internal combustion engine is the automobile, and due to its high energy density, relative availability and fully developed supply infrastructure, the most common fuels used in automobile engines in the United States of America and throughout the world are petroleum-based fuels, namely, gasoline and diesel fuel blends; however, a reliance upon petroleum-based fuels generates carbon dioxide, and the operation of millions of automobiles world-wide results in the release of a significant total amount of carbon dioxide into the atmosphere, wherein the scale of the amount generated is believed to contribute to global warming.

The petroleum acquisition and transportation operations associated with producing automotive fuels for the world also result in significant social and environmental impacts. For example, petroleum drilling and transportation discharges and by-products frequently cause significant harm to natural resources. The limited and unequal geographic distribution of significant sources of petroleum within a relatively small number of nations renders large consuming nations (such as the United States) net-importers dependent upon nations and sources outside of domestic political control which has exasperated or directly resulted in international conflicts, social unrest and even warfare in many regions of the world.

One solution is to reduce the conventional automobile's reliance on petroleum-based fuel by substituting one or more economically and socially feasible alternative fuels, energy sources or motive energy systems. Many types of alternative fuels are available or have been proposed for use with internal combustion engines, including gasoline-type biofuels such as E85 (a blend of 15% gasoline and 85% ethanol) and P-series fuels, and diesel-type biofuels such as hempseed oil fuel or other vegetable oils. Alternative power systems (illustrative but not exhaustive examples include hydrogen combustion or fuel-cell systems, compressed or liquefied natural gas or propane gas systems, and electric motor systems) may also replace an internal combustion engine or be used in combination therewith in a “hybrid” system.

However, the costs of adopting alternative fuels or power systems on a large scale are significant. In particular, the investment required to build an infrastructure necessary to support any one of the alternative fuels or power systems on a scale that will enable a migration away from the internal combustion gasoline or diesel engine is prohibitively large. Accordingly, at present, alternative fuel or power system automobiles make up only a very small fraction of the world's automobiles. A more cost-effective approach is to modify existing conventional internal combustion automobiles and support infrastructures to replace petroleum-based fuels with one or more alternative fuels.

Problems arise in modifying existing conventional automobiles in that internal combustion gasoline or diesel engines are designed to operate on fuel specifications that severely limit the possibilities of using alternative fuels since known alternative fuel blends diverge greatly from conventional petroleum-based fuel specifications. For example, 25% more E85 is required to generate the motive power of gasoline, and thus gasoline engine fuel injectors must be controlled to allow about 25% more E85 into engine combustion chambers to generate the same engine performance. One way to accomplish this is by inserting an amplifying device between the original equipment manufacturers' (OEM) fuel injection controllers and the fuel injectors, wherein the inserted amplifying device amplifies the fuel injector pulse widths to keep the fuel injectors open longer.

Yet this solution has problems. Modern engine control systems are tightly integrated and rely upon observation of a number of performance parameters in order to ensure proper engine performance. In particular, governmental vehicle emission standards require engine Onboard Diagnostic Systems (OBDs) to monitor a number of specific performance parameters for engine malfunctions that result in unacceptable increases in pollutant emissions. Inserting a pulse Width amplifying device between an OEM fuel injector pulse width generator and the fuel injectors may result in a false OBD malfunction report. In one example, the OBD thinks that the fuel injector is stuck open due to a longer-than-expected fuel injector opening from an amplified pulse width. Insertion of the amplifying device may break the direct circuit connection between the OBD and the fuel injectors, thus disabling emission monitoring in violation of governmental requirements.

Thus, what is needed is a method or system that addresses the problems discussed above, as well as others, for example, enabling a conventional automobile to accept use of a pulse width modifying element without violating emissions control regulations.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 illustrates a portion of a conventional PRIOR ART automobile fuel injector system; and,

FIG. 2 illustrates portions of an automobile fuel injector system in accordance with a preferred embodiment of the present invention;

wherein the drawings are not necessarily to scale. The drawings are merely schematic representations not intended to portray specific parameters of the invention. The drawings are intended to depict only typical embodiments of the invention, and therefore they should not be considered as limiting the scope.

### DESCRIPTION OF THE PREFERRED EMBODIMENTS

### 1. Detailed Description of the Figures

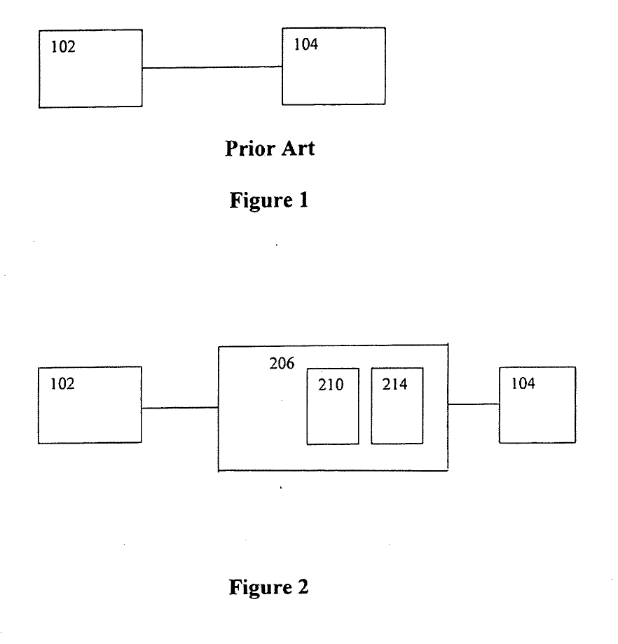

Referring now to FIG. 1, an automobile Onboard Diagnostic System (OBD) 102 is shown in communication with a conventional automobile fuel injector component 104. The fuel injector component 104 comprises a plurality of electronically controlled valves with at least one valve provided for each engine cylinder. The valves are each supplied with pressurized fuel by a fuel pump (not shown). The valves are configured to open and close many times per second. The amount of fuel supplied to the engine is determined by the amount of time the fuel injector stays open, called the “pulse width”. The length of time is controlled by pulse width signals generated by an engine control unit (ECU, not shown).

The pulse width signals control the amount and rate of fuel injected into each engine combustion chamber, and thereby control the combustion chamber air-fuel-ration (AFR). The AFR is the mass ration of air to fuel present during combustion. When all the fuel is combined with all the free oxygen within the combustion chamber, the mixture is chemically balanced and this AFR is called the stoichiometric mixture, which is ignited by the automobile ignition system in a timing coordination with cylinder head positioning and anticipated time of ignition and combustion. Each fuel has a preferred AFR or range of AFRs which will achieve optimal fuel combustion when ignited, and which is dependent in part on the amount of hydrogen and carbon found in a given amount of fuel. AFRs below preferred value(s) result in a rich mixture, wherein unburned fuel is left over after combustion and exhausted, wasting fuel and creating pollution. Alternatively, AFRs above preferred value(s) result in a lean mixture having excess oxygen, which tends to produce more nitrogen-oxide pollutants and can cause poor performance and even engine damage.

Problems arise if the fuel injector component 104 is used with alternative fuels. For example, E85 fuel combustion generates lower energy as measured in British Thermal Units (BTUs) than gasoline fuel blends, and thus higher pulse widths are required to generate comparable engine performances under similar operating parameters. FIG. 2 provides an alternative fuel injector control system according to the present invention, wherein a Pulse Modifier 206 is provided interposed between the OBD 102 and the fuel injector component 104. The Pulse Modifier 206 modifies the pulse width signals to enable the fuel injectors 104 to efficiently operate on one or more alternative fuels. For example, widening the pulse widths for E85, or narrowing the pulse widths for alternative fuels having higher BTU performance characteristics relative to gasoline or diesel fuel blends. The Pulse Modifier 206 may be programmed or otherwise configured by a manufacturer, an after-market retailer or installer, or by some other service provider. It may additionally be subsequently reprogrammed as required to provide optimal fuel injector settings for one or more specified alternative fuels.

As illustrated, the Pulse Modifier 206 is inserted between the OBD 102 and the fuel injectors 104, thus impeding direct monitoring of the fuel injectors 104 by the OBD 102. Generally, the OBD 102 is required by governmental emissions regulations to monitor the fuel injectors 104 for open circuit or closed circuit conditions. If it finds a fuel injector problem relative to a pulse width or other fuel injector signal, it must report a faulty injector by turning on a “Check Engine” light and identifying the faulty injector to a service scanner through an output port (not shown).

In order to avoid false faulty injector reports by the OBD 102, the Pulse Modifier 206 comprises a fuel injector monitor 210 configured to directly monitor the fuel injectors 104, the fuel injector monitor 210 in communication with a fuel injector simulator 214, and wherein the fuel injector simulator 214 is in circuit communication with the OBD 102.

The Pulse Modifier 206 is configured to modify fuel injector pulse width signals, for example broadening or reducing the pulse widths, and sending the modified pulse width signals to the fuel injectors 104, thus commanding the fuel injectors 104 how long to open and close. The fuel monitor 210 also checks the fuel injectors 104 for problems, is thus providing the OBD 102 monitor functions required by governmental regulations, wherein if a fault is detected by the fuel injector monitor 210, then the fuel injector simulator 214 communicates the detected problem to the OBD 102. Thus in one aspect the fuel injector simulator 214 is configured to appear to the OBD 102 as the fuel injector component 104.

In one embodiment, the fuel injector simulator 214 comprises power resister and power transistor components. Power is supplied to each power transistor by the fuel injector monitor 210 as long as no fuel injector problems are detected. If the fuel injector monitor 210 detects a problem with a fuel injector 104, power to at least one of the power transistors is turned off and electricity no longer flows through to ground through a power resister associated with the faulty injector. The OBD 102 then sees an open circuit for the faulty injector and reports the fuel injector fault, identifying the appropriate injector. Even though the Pulse Modifier 206 has broken the direct monitoring connection between the OBD 102 and the fuel injectors 104. The Pulse Modifier 206 performs the same OBD 102 fuel injector monitor functions required by government regulations and communicates fuel injector problems back to the OBD 102 in an appropriate format. If a fuel injector 104 goes bad with the Pulse Modifier 206 installed, the automobile's OBD 102 still gets notified if any of the fuel injectors 104 go bad.

The foregoing descriptions of specific embodiments of the present invention are presented for purposes of illustration and description. They are not intended to be exhaustive nor to limit the invention to the precise forms disclosed and, obviously, many modifications and variations are possible in light of the above teaching. For example, alternative fuels practiced by the present invention are not limited to E85 fuels, and other alternative fuels may be practiced. Illustrative examples include P-series fuels, diesel-type biofuels such as hempseed oil fuel or other vegetable oils, liquified natural gas, hydrogen fuels, though others may be appropriate as understood by those in the art. Such modifications and variations that may be apparent to a person skilled in the art are intended to be included within the scope of the invention as defined by the accompanying claims.

Having thus described the invention what is claimed as new and desired to be secured by Letters Patent is as follows:

1. A pulse width signal modifier, comprising:
a fuel injector monitor in communication with an engine fuel injector; and
a fuel injector simulator in communication with an onboard diagnostic component;
wherein the signal modifier is configured to modify pulse width signal output to the fuel injector;
wherein the fuel injector monitor is configured to monitor the engine fuel injector for a fault condition and communicate the fault condition to the fuel injector simulator; and,
wherein the fuel injector is configured to simulate a fuel injector fault to the onboard diagnostic component in response to a detected fault condition communicated to the fuel injector simulator by the fuel injector monitor.

2. The system of claim 1, wherein the pulse width signal is optimized for a gasoline blend, and wherein the modified pulse width signal is optimized for an E85 fuel blend.

3. The system of claim 2, wherein the modified pulse width signal is about 25% greater than the pulse width signal.

4. The system of claim 3, wherein the fuel injector simulator comprises a power transistor and a power resistor.

5. A method, comprising the steps of:
monitoring an engine fuel injector for a fault condition;
communicating a fuel injector fault condition to a fuel injector simulator in response to the step of monitoring detecting a fault condition; and
simulating a fuel injector fault to an onboard diagnostic component in response to a communicated fuel injector fault condition.

6. The method of claim 5, further comprising the steps:
modifying pulse width signal inputs from an engine control unit to generate a modified pulse width signal output to the fuel injector;
optimizing the pulse width signal for a gasoline blend; and
optimizing the modified pulse width signal for an E85 fuel blend.

7. The method of claim 6, wherein the step of modifying the pulse width signal comprises widening the pulse width signal by a widening factor.

8. The method of claim 7, wherein the step of modifying the pulse width signal comprises widening the pulse width signal by about 25%.
